(19) United States
(12) Patent Application Publication
(10) Pub. No.: US 2026/0233785 A1
(43) Pub. Date: Aug. 13, 2026

(54) OFF-ROAD VEHICLE INCLUDING METAL DEFLECTOR PLATES

(71) Applicant: Honda Motor Co., Ltd., Tokyo (JP)

(72) Inventors: Lee N. BOWERS, Springfield, OH (US); Jason W. GRUNDEY, Wapakoneta, OH (US); Cody Michael LINDEMANN, Raymond, OH (US); Michael J. HOKES, Dublin, OH (US); Dakota D. KIRTLAND, Hilliard, OH (US); Mark W. MAHUREN, Raymond, OH (US); Matthew L. TARACKO, Marysville, OH (US); Kenichi MAEDA, Raymond, OH (US); Nicholas BARRÉ, Raymond, OH (US); Benjamin D. MONINGER, Marysville, OH (US)

(21) Appl. No.: 19/050,590

(22) Filed: Feb. 11, 2025

(51) Int. Cl. B62D 25/20; B62D 25/16

(52) U.S. Cl. CPC B62D 25/2072; B62D 25/16

(57) ABSTRACT

A side-by-side, off-road vehicle can include a passenger compartment, a first wheel well, a second wheel well, a first metal deflector panel and a second metal deflector panel. The first metal deflector panel can overlap at least a portion of the first body panel in the transverse direction and a vertical direction of the vehicle. The first metal deflector panel can be configured to direct an object away from the passenger compartment if the object enters the first wheel well and strikes the first metal deflector panel. The second metal deflector panel can overlap at least a portion of the second body panel in the transverse direction and the vertical direction. The second metal deflector panel can be configured to direct an object away from the passenger compartment if the object enters the second wheel well and strikes the second metal deflector panel.

### BACKGROUND

The disclosed subject matter relates to an off-road vehicle that includes a pair of metal deflector plates located in the wheel wells of the vehicle. More particularly, the disclosed subject matter relates to methods and apparatus that can deflect an object such as, but not limited to, a tree branch that enters into the wheel well during operation of the vehicle.

Some vehicles are intended for use on an unimproved path or over unmarked terrain. These vehicles can be referred to as an off-road vehicle, an all-terrain vehicle (ATV), multipurpose utility vehicle (MUV), a recreational off-highway vehicle (ROV) or a utility terrain vehicle (UTV). The off-road vehicle can include a single seat or a plurality of seats. An off-road vehicle that includes a plurality of seats arranged in a row can be referred to as a side-by-side off-road vehicle.

The operator of the off-road vehicle can encounter obstacles or other objects while traveling on the unimproved path or over the unmarked terrain. These obstacles/objects can include, but are not limited to, tree branches, rocks, creeks, streams, etc. The off-road vehicle can be designed to have a relatively large ground clearance and a relatively large suspension travel, both of which can enable the off-road vehicle to drive over, onto and/or through some of these obstacles/objects.

### SUMMARY

Some embodiments are directed to A side-by-side, off-road vehicle that includes a passenger compartment, a first body panel, a second body panel, a first metal deflector panel and a second metal deflector panel. The first body panel can be adjacent to the passenger compartment in a longitudinal direction of the vehicle, and can have an inner side that forms at least a portion of a first wheel well. The second body panel can be adjacent to the passenger compartment in the longitudinal direction, and can have an inner side that forms at least a portion of a second wheel well. The second body panel can be spaced away from the first body panel in a transverse direction of the vehicle. The first metal deflector panel can overlap at least a portion of the first body panel in the transverse direction and a vertical direction of the vehicle. The first metal deflector panel can be configured to direct an object away from the passenger compartment if the object enters the first wheel well and strikes the first metal deflector panel. The second metal deflector panel can overlap at least a portion of the second body panel in the transverse direction and the vertical direction. The second metal deflector panel can be configured to direct an object away from the passenger compartment if the object enters the second wheel well and strikes the second metal deflector panel.

Some embodiments are directed to an off-road vehicle that includes a plurality of tubes, a passenger compartment, a first body panel, a second body panel, the first deflector panel and a second deflector panel. The plurality of tubes can be connected together to form a frame assembly that extends along a transverse direction of the vehicle and a longitudinal direction of the vehicle. The passenger compartment can be defined by the frame assembly. The first body panel can include a first inner surface that forms at least a portion of a first wheel well and second body panel can include a second inner surface that forms at least a portion of a second wheel well. The second wheel well can be spaced away from the first wheel well in a transverse direction of the off-road vehicle. The first metal deflector panel can be mounted onto the frame assembly at a location that is adjacent the first wheel well, and at least a portion of the first metal deflector panel can be spaced away from the first body panel in the longitudinal direction. The first metal deflector panel can be configured to direct an object away from the passenger compartment if the object enters the first wheel well and strikes the first metal deflector panel. The second metal deflector panel can be mounted onto the frame assembly at a location that is adjacent the second wheel well, and at least a portion of the second metal deflector panel can be spaced away from the second body panel in the longitudinal direction. The second metal deflector panel can be configured to direct an object away from the passenger compartment if the object enters the second wheel well and strikes the second metal deflector panel.

Some embodiments are directed to an off-road vehicle that can include a frame assembly, a bumper assembly, a passenger compartment, a first body panel, a second body panel, a first suspension link, a cushion, a wheel, a first metal deflector panel and a second metal deflector panel. The frame assembly can extend along a transverse direction of the vehicle and a longitudinal direction of the vehicle. The bumper assembly can be mounted onto and extend away from the frame assembly. The passenger compartment can be located within the frame assembly. The first body panel that can include a first inner surface that forms at least a portion of a first wheel well and the second body panel that can include a second inner surface that forms at least a portion of a second wheel well. The second wheel well can be spaced away from the first wheel well in a transverse direction of the off-road vehicle. The first suspension link can be pivotally mounted on the frame assembly, the cushion can be connected to and extend from the frame assembly and the first suspension link, and the wheel can be pivotally connected to the first suspension link. The first metal deflector panel can be mounted onto the frame assembly at a location that is between the first wheel and the first body panel in the longitudinal direction. The first metal deflector panel can be configured to direct an object away from the passenger compartment if the object enters the first wheel well and strikes the first metal deflector panel. The second metal deflector panel can be mounted onto the frame assembly at a location that is between the second wheel and the second body panel in the longitudinal direction. The second metal deflector panel can be configured to direct an object away from the passenger compartment if the object enters the second wheel well and strikes the second metal deflector panel.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a perspective view of an off-road vehicle made in accordance with principles of the disclosed subject matter.

FIG. 2 is a front view of a portion of the off-road vehicle of FIG. 1 with a pair of metal deflector panels shown with emphasis.

FIG. 3 is a front view of the right metal deflector panel of the off-road vehicle of FIG. 1.

FIG. 4 is a front view of the left metal deflector panel of the off-road vehicle of FIG. 1.

FIG. 5 is a top view of a frame assembly and the metal deflector panel of the off-road vehicle of FIG. 1.

FIG. 6 is a front view of a front portion of the frame assembly and the metal deflector panel of the off-road vehicle of FIG. 1.

FIG. 7 is rear view of the front portion of the frame assembly and the metal deflector panel of the off-road vehicle of FIG. 1.

FIG. 8 is perspective view of the front portion of the frame assembly and the metal deflector panel of the off-road vehicle of FIG. 1.

FIG. 9 is a side view of a bolt for connecting either of the metal deflector panels to the frame assembly of the off-road vehicle of FIG. 1.

FIG. 10 is a plan view of the bolt of FIG. 9.

FIG. 11A is a front view of a portion of the off-road vehicle of FIG. 1 with a pair of guard plates shown with emphasis.

FIG. 11B is a front view of a portion of the off-road vehicle of FIG. 1 and shows three different entry zones for each front wheel well of the off-road vehicle of FIG. 1.

FIG. 12 is a perspective view of the front portion of the frame assembly of the off-road vehicle of FIG. 1 and a first alternate embodiment of the left metal deflector panel.

FIG. 13 is a perspective view of the front portion of the frame assembly of the off-road vehicle of FIG. 1 and a second alternate embodiment of the left metal deflector panel.

FIG. 14 is a front view of a different portion of the frame assembly of the off-road vehicle of FIG. 1 that includes a cross beam and a metal blocker plate of the off-road vehicle of FIG. 1.

FIG. 15 is an enlarged portion of FIG. 14 and shows a fourth entry zone for the left wheel well.

FIG. 16 is a perspective view of the pair of metal deflector panels, the cross beam and the metal blocker plate of the off-road vehicle of FIG. 1.

FIG. 17 is a front view of the left deflector panel, a portion of the cross beam and the metal blocker plate of FIG. 16.

FIG. 18 is a side view of the left deflector panel, a portion of the cross beam and the metal blocker plate of FIG. 16.

FIG. 19 is a perspective view of the left deflector panel, a portion of the cross beam and the metal blocker plate of FIG. 16.

FIG. 20 is a perspective view of the metal blocker plate of the off-road vehicle of FIG. 1.

FIG. 21 is a cross-sectional view taken along line 21-21 of FIG. 17 and shows a body panel in phantom.

FIG. 22 is a perspective view of the metal blocker plate, a portion of the left deflector panel, a portion of the cross beam, and a gap between the metal blocker plate and the left deflector panel.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

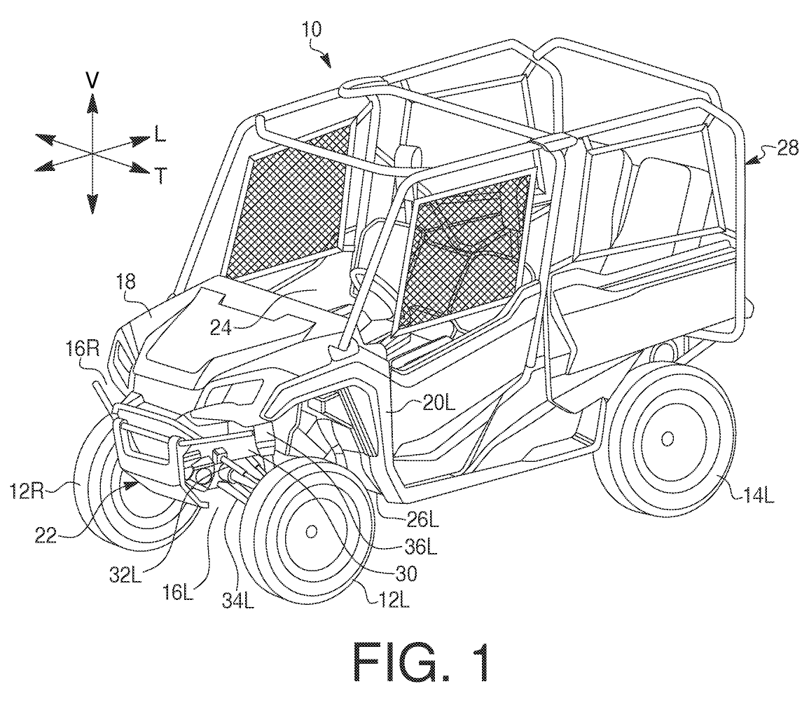

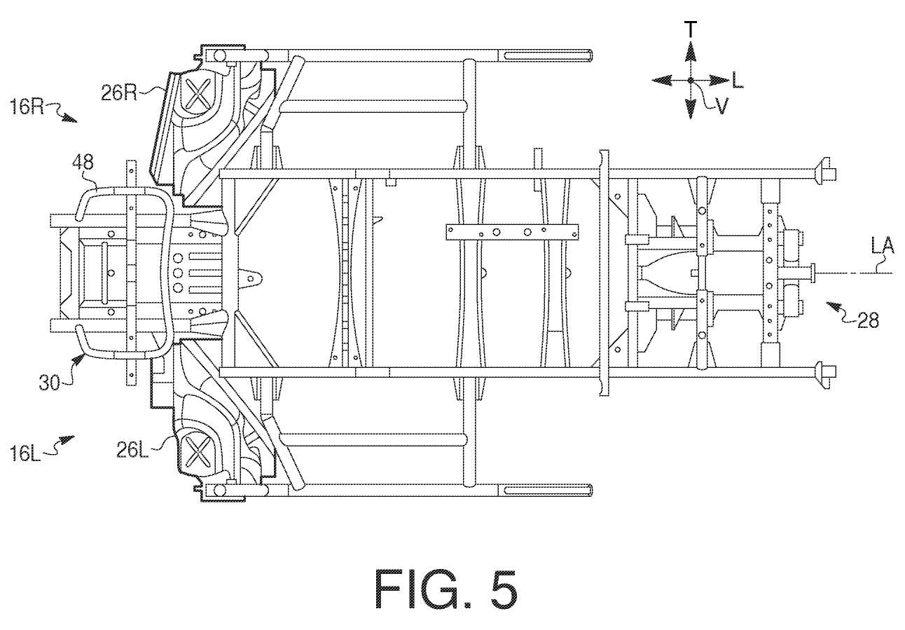

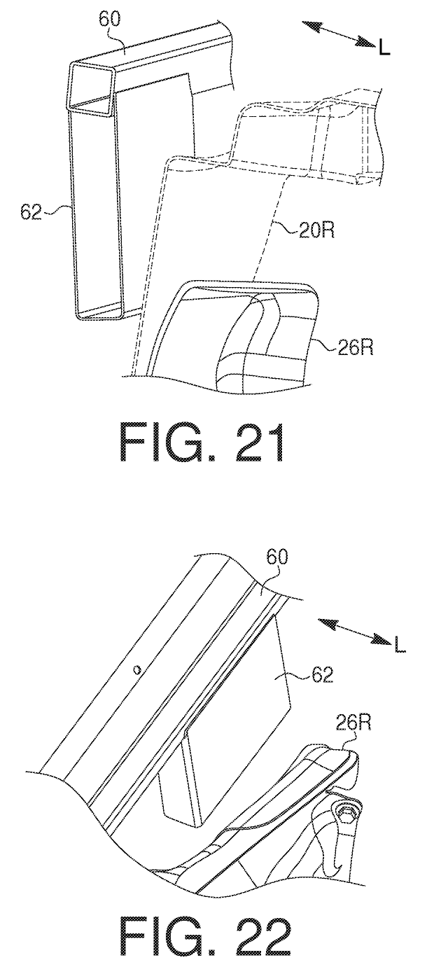

FIG. 1 is a perspective view of an exemplary vehicle 10 made in accordance with principles of the disclosed subject matter. The vehicle 10 shown in FIG. 1 is specialized for use on an unimproved path or on an unmarked path, and can be referred to, for example, as an off-road vehicle, an all-terrain vehicle (ATV), multipurpose utility vehicle (MUV), a recreational off-highway vehicle (ROV), a utility terrain vehicle (UTV) or a side-by-side all-terrain vehicle (SxS, or SxS ATV). The vehicle 10 can extend in a longitudinal direction L, a transverse direction T and vertical direction V. The vehicle 10 can include a pair of front wheels 12L, 12R, a pair of left rear wheels 14L, a pair of wheel wells 16L, 16R, a plurality of body panels 18, 20L, a bumper assembly 22 and a passenger compartment 24. The vehicle 10 can include a right rear wheel that is obstructed from view in FIG. 1 and is aligned with the left rear wheel 14L. The right wheel well 16R is shown in FIG. 5. The vehicle 10 can include a lower body panel 20R (shown in phantom in FIG. 21) on the right side that is a mirror image of the lower body panel 20L.

The front wheels 12L, 12R can be movable within a respective one of the wheel wells 16L, 16R along the vertical direction V. The wheel wells 16L, 16R can be much larger than the wheels 12L, 12R in order to allow for a large suspension travel so that the vehicle 10 can travel across uneven terrain. Thus, the wheel wells 16L, 16R can include a large empty space behind each of the wheels 12L, 12R. Further, the front end of the wheel wells 16L, 16R can include an opening that extends along the transverse direction T and the vertical direction V and is located between the respective one of the front wheels 12L, 12R and the bumper assembly 22.

During use, the operator of the vehicle 10 can encounter various object(s), such as a tree branch that has a free end spaced away from the ground and opposing the front opening of one of the wheel wells 16L, 16R. It is possible for the tree branch to enter the wheel well 16L or 16R and impact onto the lower body panel 20L, 20R at a location that is adjacent to the passenger compartment 24. Thus, it can be advantageous to reinforce the vehicle 10 against possible intrusion of objects such as a tree branch into the passenger compartment 24 via either or both of the wheel wells 16L,16R.

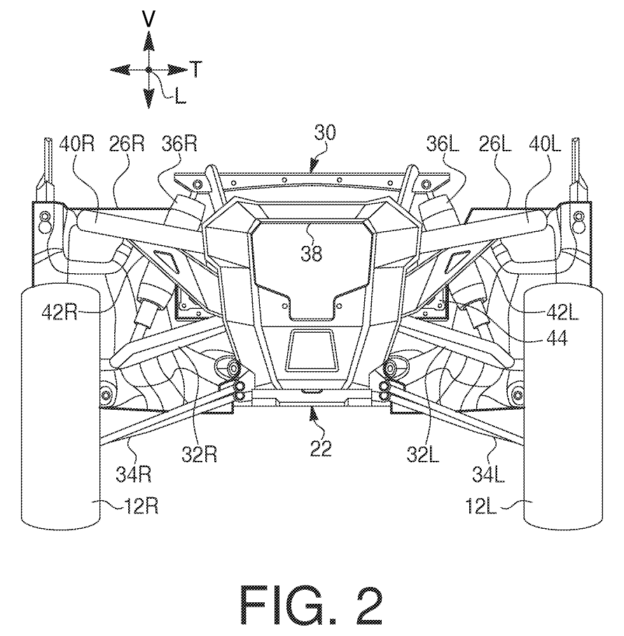

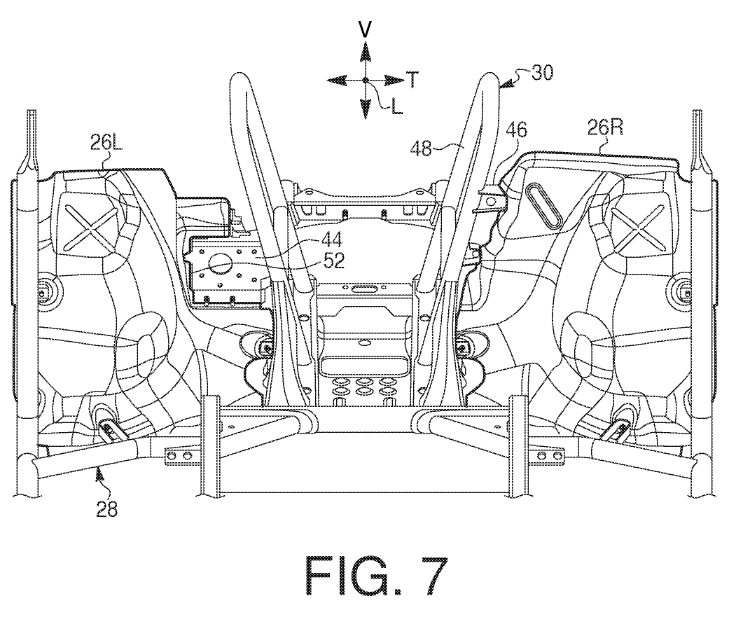

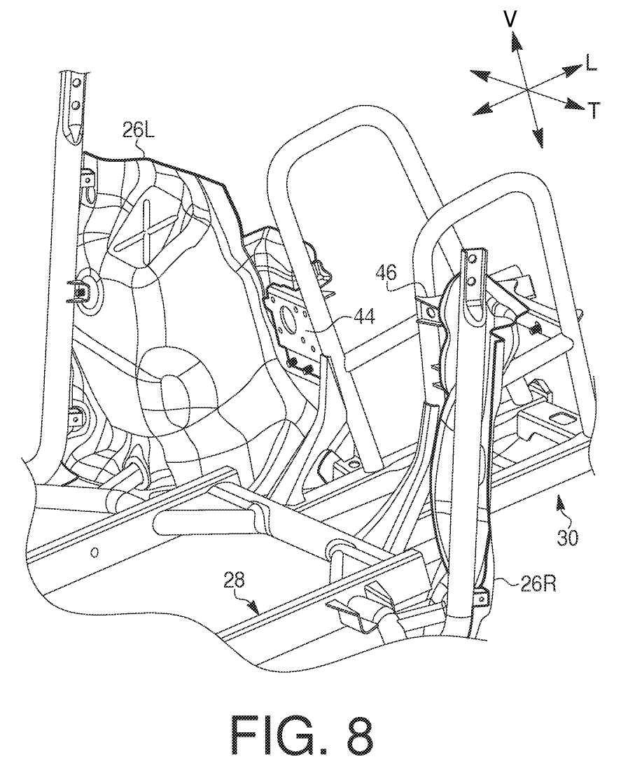

Referring to FIGS. 1 and 2 collectively, the vehicle 10 can include a pair of metal deflector panels 26L, 26R configured to prevent or mitigate against intrusion of objects into the passage compartment 24 via either of wheel wells 16L, 16R. The right metal deflector panel 26R is obstructed from view in FIG. 1. The perimeter of each of the metal deflector panels 26L, 26R is shown in FIGS. 2, 5-8, and 14 with heavier lines to more clearly view the metal deflector panels 26L, 26R. Each of the metal deflector panels 26L, 26R can be located in a respective one of the wheel wells 16L, 16R and in front of a respective one of the lower body panels 20L, 20R. That is, the lower body panels 20L , 20R can be located between the metal deflector panels 26L, 26R and the passenger compartment 24 in the longitudinal direction L. The deflector panels 26L, 26R can be configured to deflect an object such as a tree branch toward a target component of the vehicle 10 if the tree branch enters the front opening in the wheel well 16L, or 16R and strikes the respective metal deflector panel 26L, 26R. The target component can be the front wheel 12L, 12R, or one or more suspension members, as will be described in more detail below. The metal deflector panels 26L, 26R can be configured to apply a bending moment onto the tree branch and break the tree branch while it is in contact with deflector panel 16L or 16R and the target component so that the free end of the tree branch does not enter the passenger compartment 24.

The metal deflector panels 26L, 26R can have any appropriate shape and surface contour that can facilitate the deflection and breaking of an object such as a tree branch that impacts the left metal deflector panel 26L or the right metal deflector panel 26R. The perimeter shape and contoured surface of each of the metal deflector panels 26L, 26R can be configured to conform to adjacent components inside the wheel wells 16L, 16R such as, but not limited to, the wheels 12L, 12R and the lower body panels 20L, 20R.

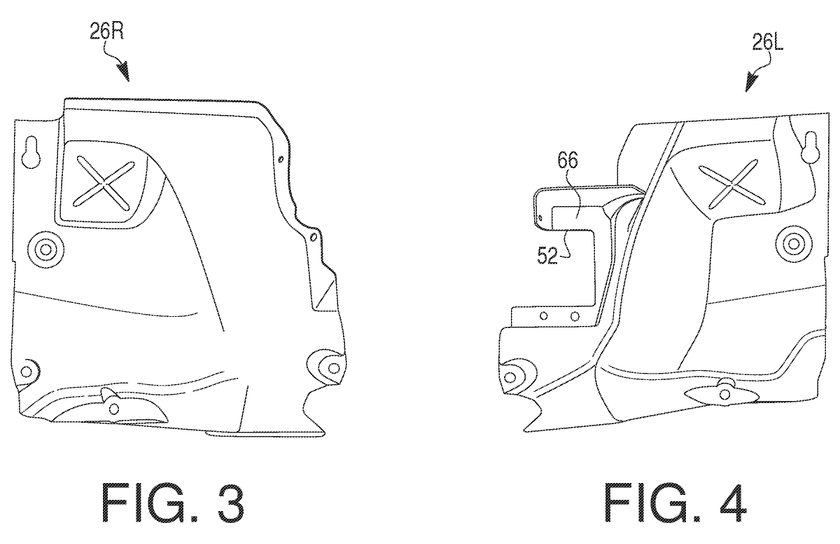

Referring to FIGS. 3 and 4, the metal deflector panels 26L, 26R can have an irregular-shaped outer perimeter. The shape of the outer perimeter of the left metal deflector panel 26L can be different from the shape of the outer perimeter of the right metal deflector panel 26R. The left metal deflector panel 26L can include a recessed perimeter section 52 and flange 64. Referring to FIGS. 3-6, the left metal deflector panel 26L can be asymmetric with respect to the right deflector panel 26R about a longitudinal axis LA of the vehicle 10 that extends in the longitudinal direction L and is centered on the vehicle 10 in the transverse direction T.

Referring to FIGS. 1 and 5, the vehicle 10 can include a frame assembly 28 that supports the passenger compartment 24 and surrounds the passenger compartment 24. The frame assembly 28 can include a front sub-frame 30 to which the front wheels 12L, 12R are movably connected.

Referring to FIGS. 5-8, the metal deflector panels 26L, 26R can be mounted onto the front sub-frame 30 and other portions of the frame assembly 28. The metal deflector panels 26L, 26R can protrude from the front sub-frame 30 along the transverse direction T and from another portion of the frame assembly 28 in the vertical direction V.

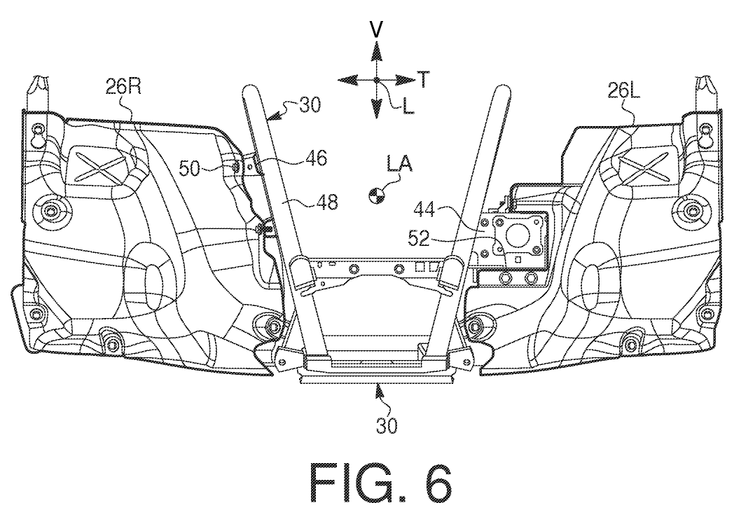

Referring to FIGS. 6-8, the vehicle 10 can include a master cylinder bracket 44 that is mounted onto the front sub-frame 30. The master cylinder bracket 44 can receive and support a brake master cylinder and/or a fluid reservoir for the brake master cylinder. The master cylinder bracket 44 can be connected to the front sub-frame 30 by any appropriate manner such as, but not limited to, welding, adhesive, threaded fasteners, clips, and/or clamps. The recessed perimeter section 52 of the left metal deflector panel 26L can wrap around at least a portion of the master cylinder bracket 44.

Returning to FIG. 4, the left metal deflector panel 26L can include a flat surface 66 that extends along the recessed perimeter section 52. The flange 64 can protrude from the flat surface 66 along the longitudinal direction L and the transverse direction T. The flange 64 can provide additional protection to the master cylinder.

Referring to FIGS. 5, 7 and 8, the frame assembly 28 can include a plurality of frame members that are connected together by any appropriate manner such as, but not limited to, welding, adhesive, threaded fasteners, adhesive, clamps and/or clips. Each of the frame members can be a hollow tube have various cross-sections, such as a rectangular or circular cross-section.

Referring to FIGS. 5-8, each of the metal deflector panels 26L, 26R can be mounted onto the frame assembly 28 by any appropriate manner that permits the metal deflector panels 26L, 26R to resist an object such as a tree branch that impacts either of the deflector panels 26L, 26R while the vehicle 10 is travelling. For example, the frame assembly 28 can include a plurality of brackets 46 welded onto one or more of the frame members. As shown in each of FIGS. 6-8, at least one bracket 46 of the plurality can be welded onto a frame member 48 of the front sub-frame 30. A plurality of bolts 50 can connect the metal deflector panels 26L, 26R to the brackets.

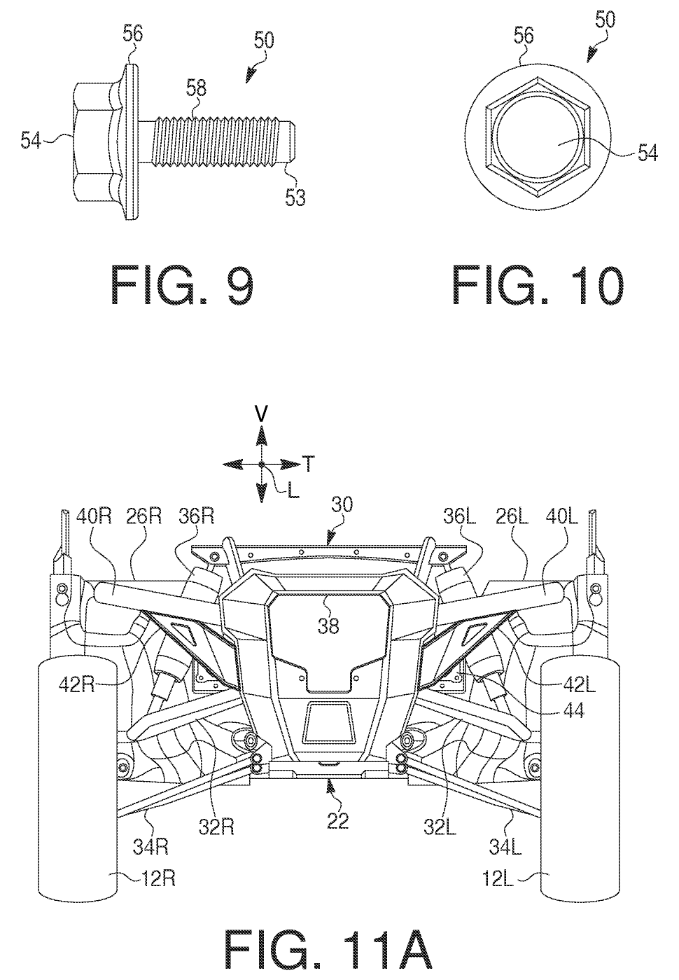

Referring to FIGS. 9 and 10, the bolt 50 can include a head 54, a flange 56 and a shaft 58. The flange 56 can be enlarged as compared to a standard bolt having a shaft that is the same diameter as the shaft 58. The flange 56 can be oversized as compared to a standard bolt having a head that is the same size as the head 54. For example, the head 54 can be sized according to a M12 bolt, the flange 56 can be oversized as compared to a M12 flanged bolt, and the shaft 58 can be sized according to a M10 bolt. The larger head 54 and flange 56 can enhance the contact pressure and overall strength for the connection between the metal deflector panels 26L, 26R and the frame assembly 28. The shaft 58 can include an unthreaded tip 53 that aligns the bolt 50 with the bolt hole in one of the metal deflector panels 26L, 26R during assembly to reduce or prevent cross-threading.

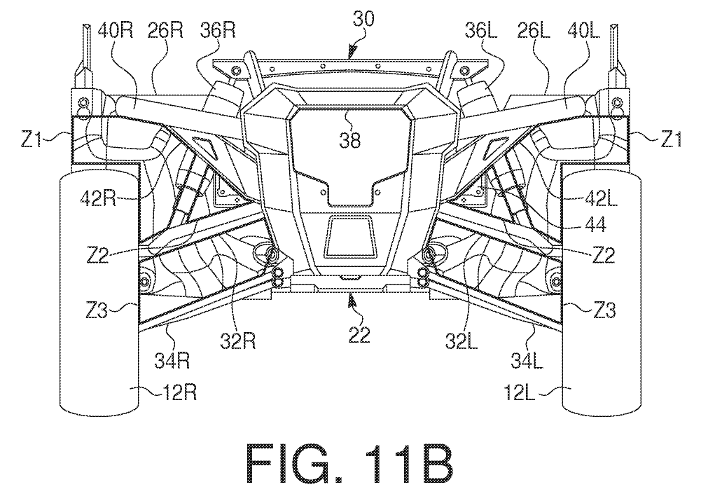

Referring to FIGS. 11A and 11B, the vehicle 10 can include a plurality of suspension links 32L, 32R, 34L, 34R and a pair of cushions 36L, 36R. Each of the suspension links 32L, 32R, 34L, 34R can be connected to the front sub-frame 30 and a respective one of the front wheels 12L, 12R by any appropriate manner that can permit the suspension links 32L, 32R, 34L, 34R to pivot relative to the each of the front sub-frame 30 and the respective one of the front wheels 12L, 12R. The cushions 36L, 36R can be connected to the front sub-frame 30 and a respective one of the front wheels 12L, 12R by any appropriate manner that can permit the cushions 36L, 36R to pivot relative to the each of the front sub-frame 30 and the respective one of the front wheels 12L, 12R. Each of the cushions 36L, 36R can be referred to as a damper, a shock absorber, or a shock.

The bumper assembly 22 can include a bumper main body 38, a pair of bumper beams 40L, 40R and a pair of metal guard plates 42L, 42R. The perimeter of each of the metal guard plates 42L, 42R is shown in FIG. 11A with heavier lines to more clearly view the metal guard plates 42L, 42R. Each of the bumper main body 38 and the bumper beams 40L, 40R can be configured to resist a predetermined impact force and/or impact energy that is less than a predetermined threshold and deform in response to impact force and/or impact energy is equal to or greater than the predetermined threshold.

The bumper main body 38 can be a panel that includes an opening centered in the transverse direction T. The bumper main body 38 can be connected to the front sub-frame 30 by any appropriate manner such as, but not limited to, welding, threaded fasteners, adhesive, clips, and/or clamps.

The bumper beams 40L, 40R can extend away from the bumper main body 38 and each other in the transverse direction T. The bumper beams 40L, 40R can be cylindrical tubes that are connected to the bumper main body by any appropriate manner such as, but not limited to, welding, adhesive, threaded fasteners, clips and/or clamps. The bumper beams 40L, 40R can be inclined relative to the transverse direction T. Each of the bumper beams 40L, 40R can have a free end that overlaps a respective one of the wheels 12L, 12R and is spaced above the respective one of the wheels in the vertical direction V.

The guard plates 42L, 42R can be made from any appropriate metal material. Each of the guard plates 42L, 42R can be a polygonal panel that is elongated in a direction that is inclined with respect to the transverse direction T. A first end of each of the guard plates 42L, 42R can be connected to the bumper main body 38 by any appropriate manner such as, but not limited to, welding, adhesive, threaded fasteners, clips, and/or clamps. A second end of the left guard plate 42L can be connected to the first bumper beam 40L and a second end of the right guard plate 42R can be connected to the right bumper beam 40R by any appropriate manner such as, but not limited to, welding, adhesive, threaded fasteners, clips, and/or clamps. The left guard plate 42L can extend from each of the bumper main body 38 and the first bumper beam 40L and the right guard plate 42R can extend from each of the bumper main body 38 and the right bumper beam 40R.

The left guard plate 42L can overlap at least a portion of the master cylinder bracket 44. In the transverse direction T and the vertical direction V. The left guard plate 42L can deflect an object that might otherwise impact the brake master cylinder and/or the fluid reservoir.

FIG. 11B shows three zones Z1, Z2, Z3 by which an object such as a tree branch can enter either of the wheel wells 16L,R. The perimeters of the zones Z1, Z2, Z3 are indicated with heavier lines to more clearly view the zones Z1, Z2, Z3. The three zones Z1, Z2, Z3 for the right wheel well 16R can be mirror images of the three zones Z1, Z2, Z3 for the left wheel well 16L, and the following description for the left wheel well 16L applies to the three zones Z1, Z2, Z3 of the right wheel well 16R and the corresponding structures on the right side of the vehicle 10.

For the following discussion, an object, such as a tree branch, includes a first end that enters the left wheel well 16L via one of the three zones Z1, Z2, Z3 and a second end that is seated in front of the vehicle 10 on a travel path of the vehicle 10. The second end of the tree branch can be firmly seated in the ground or against another object such as a rock, log or tree trunk such that the second end remains stationary when the first end of the tree branch impacts on the left metal deflector panel 26L.

The left guard plate 42L, the left bumper beam 40L, the outer edge of the left deflector panel 26L, the left wheel 12L, the left first suspension link 32L and the left cushion 36L can bound the first zone Z1 as viewed in the longitudinal direction L from in front of the vehicle 10. The left deflector panel 26L can be configured to push the tree branch against the left wheel 12L and bend the tree branch against the left wheel 12L if the first end of the tree branch enters the first zone Z1. The bending moment imparted onto the tree branch by the left metal deflector plate 26L and the left wheel 12L can break the tree branch and eject the broken portion from the left wheel well 16L in a direction that is away from the passenger compartment 24. Thus, the left metal deflector panel 26L can deflect away from the passenger compartment 24 a tree branch that enters the first zone Z1.

The left guard plate 42L, left cushion 36L and the left first suspension link 32L can bound the second zone Z2 as viewed in the longitudinal direction L from in front of the vehicle 10. The left guard plate 42L can push the first end of the tree branch away from the master cylinder bracket 44 and toward the left cushion 36L. The left deflector panel 26L can be configured to push the tree branch against the left cushion 36L and bend the tree branch against the left cushion 36L if the first end of the tree branch enters the second zone Z2. The bending moment imparted onto the tree branch by the left metal deflector plate 26L and the left cushion 36L can break the tree branch and eject the broken portion from the left wheel well 16L in a direction that is away from the passenger compartment 24. Thus, the left metal deflector panel 26L can deflect away from the passenger compartment 24 a tree branch that enters the second zone Z2.

The bumper main body 38, the left first suspension link 32L, the left wheel 12L and the left second suspension link 34L can bound the third zone Z3 as viewed in the longitudinal direction L from in front of the vehicle 10. The left deflector panel 26L can be configured to trap the tree branch between the left suspension links 32L, 34L and bend the tree branch against the left suspension links 32L, 34L if the first end of the tree branch enters the third zone Z3. The bending moment imparted onto the tree branch by the left metal deflector plate 26L and the left suspension links 32L, 34L can break the tree branch and eject the broken portion from the left wheel well 16L in a direction that is away from the passenger compartment 24. Thus, the left metal deflector panel 26L can deflect away from the passenger compartment 24 a tree branch that enters the third zone Z3.

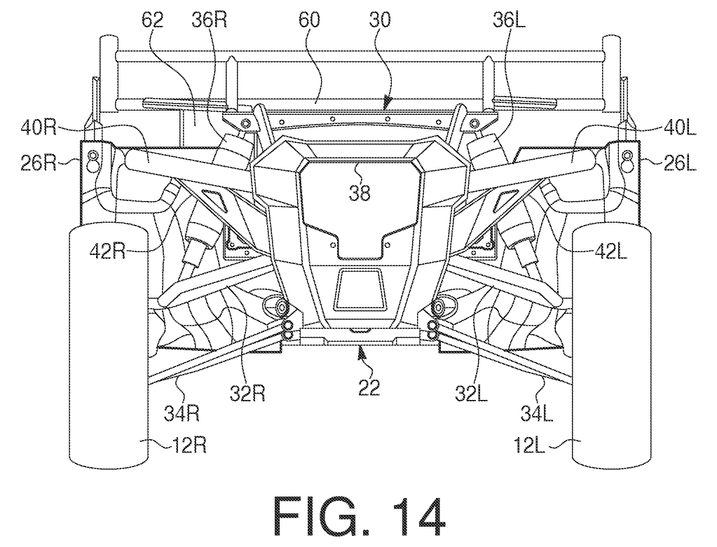

Referring to FIG. 14, the frame assembly 28 can include a cross beam 60 that extends across the passenger compartment 24 in the transverse direction T. The cross beam 60 can be spaced above the metal deflector plates 26L, 26R in the vertical direction V by a gap, and extends along the metal deflector plates 26L, 26R in the transverse direction T. The cross beam 60 can be a member of a support frame that supports an instrument panel of the vehicle 10.

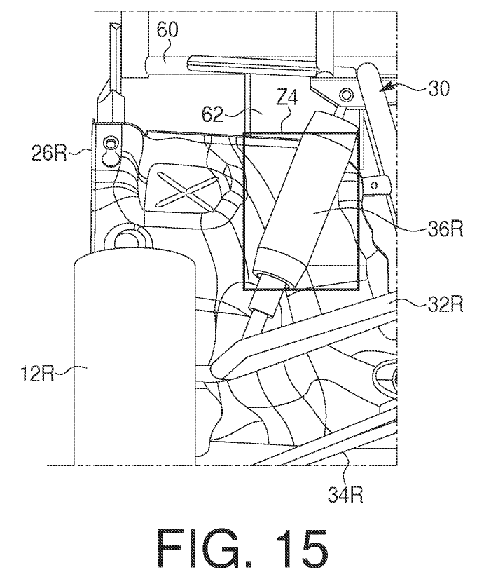

Referring to FIG. 15, the right wheel well 16R can include a fourth zone Z4 that is spaced inboard from the right wheel 12R in the transverse direction T and overlaps the right cushion 36R. The fourth zone Z4 can be a generally rectangular zone that is generally centered on the right cushion in the transverse direction T and the vertical direction V. The right cushion 36R can extend diagonally across the fourth zone Z4.

It is possible for the right cushion 36R to trap and push the tree branch toward the upper edge of the right metal deflector panel 26R if the first end of the tree branch enters the right wheel well 16R via the fourth zone Z4. The tree branch can deform the right metal deflector panel 26R if the impact force and/or impact energy exceeds a predetermined threshold. The tree branch could enter the passenger compartment 24 if the tree branch sufficiently deforms the right metal deflector panel 26R.

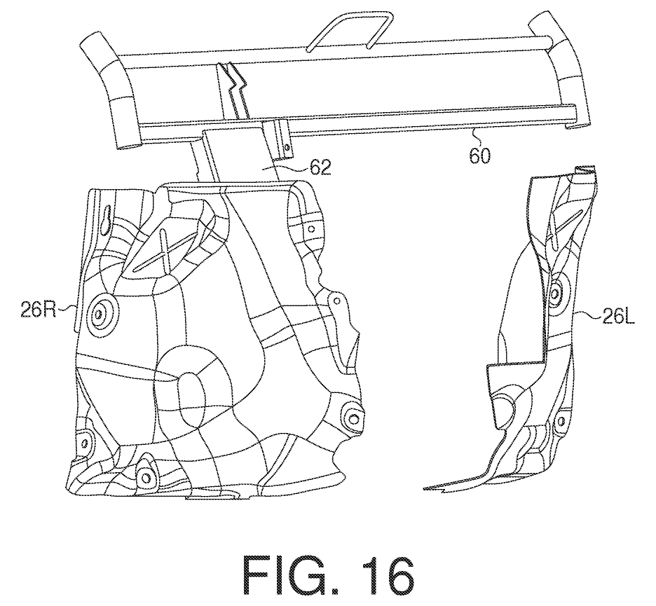

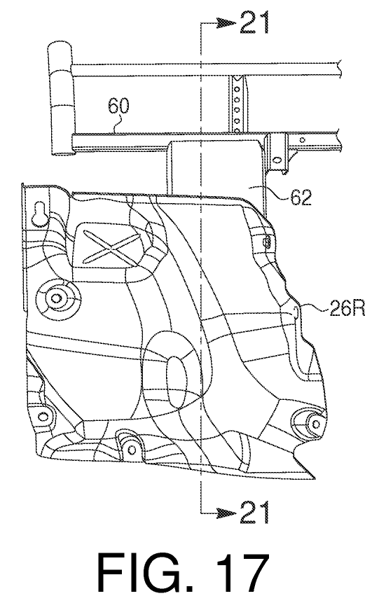

Referring to FIGS. 14-19, the vehicle 10 can include a metal blocker plate 62 that is connected to the cross beam 60 and spans the gap along the vertical direction V. The metal blocker plate 62 can be configured to limit displacement of the right metal deflector panel 26R due to an impact with the tree branch that has entered the right wheel well 16R via the fourth zone Z4.

The metal blocker plate 62 can be connected to and extend from a bottom portion of the cross beam 60 by any appropriate manner such as, but not limited to, welding, adhesive, threaded fasteners, clamps and/or clips. The metal blocker plate 62 can extend along the vertical direction V and to a location that is below the upper edge of the right metal deflector panel 26R. At least a portion of the metal blocker plate 62 can overlap right metal deflector panel 26R. Referring to FIGS. 15-22, the metal block plate 62 can be a generally rectangular, hollow box.

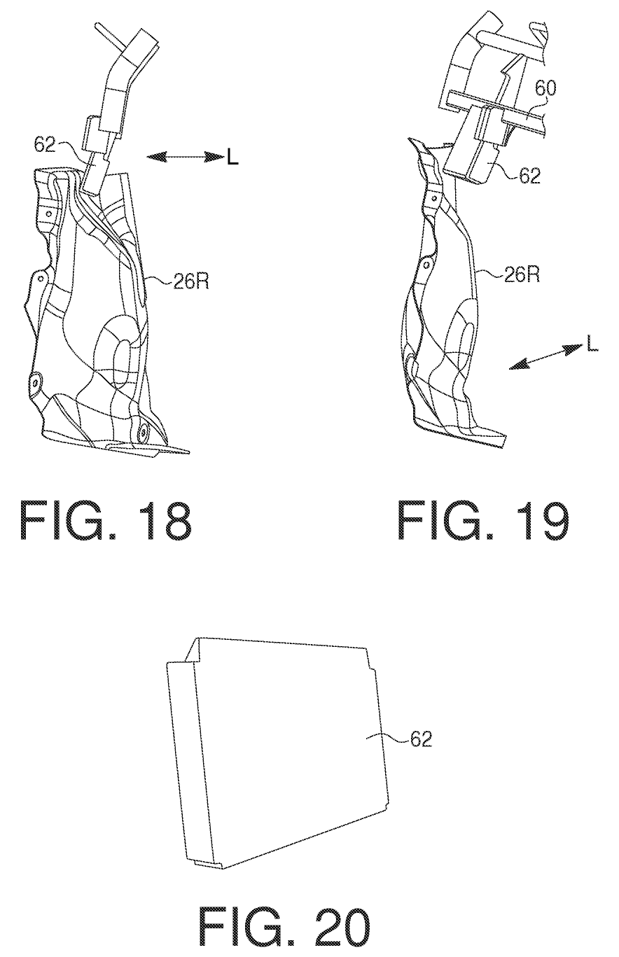

Referring to FIGS. 18, 19, 21 and 22, the metal blocker plate 62 can be spaced away from the rear surface of the right metal deflector panel 26R in the longitudinal direction L. The right metal deflector panel 26R can be configured to deform into the gap between the right metal deflector panel 26R and the metal blocker plate 62 if the tree branch enters the fourth zone Z4. This deformation can absorb at least some of the energy transferred by the tree branch impacting onto the right metal deflector panel 26R. The metal blocker plate 62 can be configured to impede or prevent further deformation of the right metal deflector panel 26R if the right metal deflector panel 26R abuts the metal blocker plate 62. Thus, the metal blocker plate 62 can limit displacement of the right metal deflector panel 26R due to an impact with the tree branch that has entered the right wheel well 16R via the fourth zone Z4.

FIG. 21 shows the right lower body panel 20R in phantom. The right lower body panel 20R can be located between the metal blocker plate 62 and the right metal deflector panel 26R in the longitudinal direction L.

The dimensions of the recessed perimeter section 52 of the left metal deflector panel 26L can be complimentary to the dimensions of the master cylinder bracket 44 such that left metal deflector panel 26L abuts that the master cylinder bracket 44 without a gap.

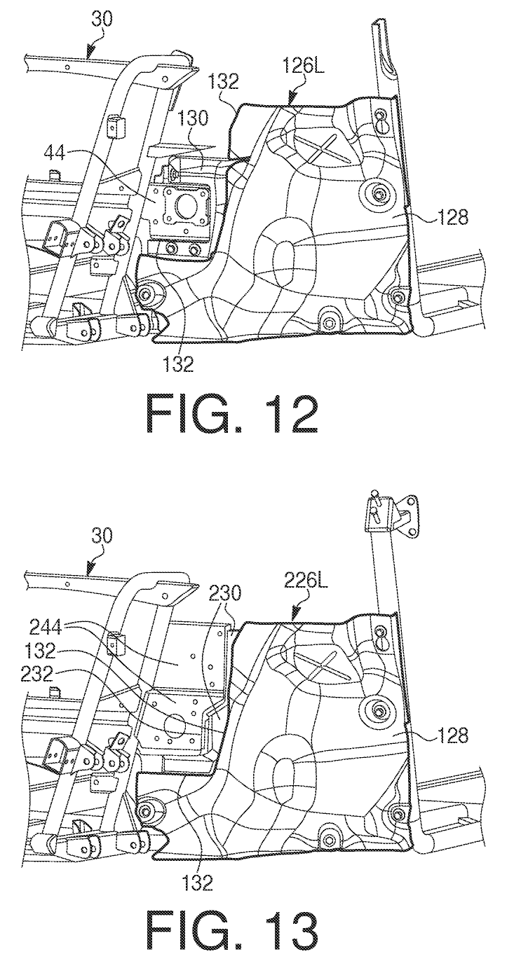

In contrast, FIG. 12 shows a first alternate embodiment of a left metal deflector panel 126L and FIG. 13 a second alternate embodiment of a left metal deflector panel 226L that can accommodate future changes in the shape and size of the master cylinder bracket without changing the shape or size of the respective recessed perimeter portion 152.

Referring to FIG. 12, the master cylinder bracket 44 can be the same as that shown in FIGS. 6-8. Instead of being a single piece like the left metal deflector panel 26L of FIGS. 1-11 and 14-22, the left metal deflector panel 126L can be formed from a main panel 128 and an adapter panel 130. The main panel 128 is shown with a heavier line so that the main panel 128 can be more clearly viewed.

The main panel 128 can include a generally L-shaped perimeter section 132 that extends along and is spaced away from the master cylinder bracket 44. The L-shaped perimeter section 132 can be configured to accommodate changes in the shape and size of the master cylinder bracket 44 without changing the size or shape of the L-shaped perimeter section 132 or main panel 128.

The adapter panel 130 can include a recessed perimeter section 152 that is dimensioned to be complimentary to the master cylinder bracket 44 such that the adapter panel 130 abuts master cylinder bracket 44 without a gap. The adapter panel 130 can be connected to the main panel 128 by any appropriate manner such as but not limited to welding, adhesive, threaded fasteners, clamps, and/or clips.

The master cylinder bracket 244 shown in FIG. 13 can be different from the master cylinder bracket 44 of FIGS. 6-8 and 12 in both size and shape. The left metal deflector panel 226L of FIG. 13 can include the main panel 128 and an adapter panel 230. The main panel 128 can be the same as the main panel 128 of FIG. 12 and is shown with a heavier line so that the main panel 128 can be more clearly viewed.

The master cylinder bracket 244 can be larger along the vertical direction V as compared to the master cylinder bracket 44 of FIGS. 6-8 and 12. The left metal deflector panel 226L of FIG. 13 can include an adapter panel 230 that is different in size and shape as compared to the adapter panel 130 of FIG. 12. The adapter panel 230 can include a contoured edge 232 that is complimentary to the master cylinder bracket 244 such that the adapter panel 230 can abut the master cylinder bracket 244 without a gap.

Thus, the main panel 128 can be used with both the left metal deflector panel 126L of Fig, 12 and the left metal deflector panel 226L of FIG. 13. This can reduce the investment for the tooling to make and assemble the main panel 128 onto the vehicle 10. Although the adapter panels 130, 230 have a tooling cost, it can be less than the tooling cost to change the design of the left metal deflector panel 26L to accommodate the revised master cylinder bracket 244.

The left metal deflector panels 126L, 226L can deflect a tree branch in the same or similar manner as described above with respect to FIG. 11B. Accordingly, the first and second alternate embodiments of the left metal deflector panel can accommodate versatility in the design of the adjacent structure(s) while maintaining the deflection performance.

While certain embodiments of the invention are described above, it should be understood that the invention can be embodied and configured in many different ways without departing from the spirit and scope of the invention.

The metal deflector panels described above can have an irregular perimeter shape and a contoured impact surface. However, alternate embodiments can include a metal deflector panel that has a regular perimeter shape such as, but not limited to, a regular polygon or an oval. Alternate embodiments can include a metal deflector that has a flat impact surface that extends completely across the metal deflector panel in the transverse direction T and the vertical direction V.

The metal deflector panels can be made from any appropriate metal material or metal alloy such as, but not limited to, steel, aluminum, aluminum alloys, titanium, titanium alloys. The metal deflector panels can be formed from sheet metal that is stamped into the desired size and shape, cast from molten metal, or extruded.

In alternate embodiments, the master cylinder bracket 44 could be omitted from the vehicle 10. Thus, alternate embodiments can include a pair of metal deflector panels that are the same as or similar to each other, or mirror images of each other.

What is claimed is:

1. A side-by-side, off-road vehicle comprising:
a passenger compartment;
a first body panel adjacent to the passenger compartment in a longitudinal direction of the vehicle, the first body panel has an inner side that forms at least a portion of a first wheel well;
a second body panel adjacent to the passenger compartment in the longitudinal direction, the second body panel has an inner side that forms at least a portion of a second wheel well, the second body panel is spaced away from the first body panel in a transverse direction of the vehicle;
a first metal deflector panel overlapping at least a portion of the first body panel in the transverse direction and a vertical direction of the vehicle, the first metal deflector panel is configured to direct an object away from the passenger compartment if the object enters the first wheel well and strikes the first metal deflector panel; and
a second metal deflector panel overlapping at least a portion of the second body panel in the transverse direction and the vertical direction, the second metal deflector panel is configured to direct an object away from the passenger compartment if the object enters the second wheel well and strikes the second metal deflector panel.

2. The side-by-side, off-road vehicle according to claim 1, wherein
the first body panel is between the first metal deflector panel and the passenger compartment in the longitudinal direction, and
the second body panel is between the second metal deflector panel and the passenger compartment in the longitudinal direction.

3. The side-by-side, off-road vehicle according to claim 1, further comprising:
a metal blocker plate located between the passenger compartment and the second metal deflector panel in the longitudinal direction, the metal blocker plate is spaced away from the second metal deflector panel in the longitudinal direction, wherein
the second metal deflector panel is configured to deform and contact the metal blocker plate if an impact energy of an object striking the second metal deflector panel is greater than a predetermined threshold.

4. The side-by-side, off-road vehicle according to claim 3, further comprising:
a frame assembly supporting the passenger compartment and including a cross beam that extends across the passenger compartment in the transverse direction, the cross beam is spaced above the first deflector plate and the second metal deflector plate in the vertical direction by a gap, the cross beam extends along the first deflector plate and the second metal deflector plate in the transverse direction, wherein
the metal blocker panel is connected to the cross beam and spans the gap in the vertical direction.

5. The side-by-side, off-road vehicle according to claim 3, wherein the metal blocker plate is a hollow box.

6. The side-by-side, off-road vehicle according to claim 3, wherein the second body panel is located between the metal blocker plate and the second metal deflector panel in the longitudinal direction.

7. The side-by-side, off-road vehicle according to claim 1, further comprising:
a frame assembly supporting the passenger compartment
a master cylinder bracket mounted on the frame assembly, wherein
each of the first body panel the second body panel are connected to the frame assembly,
each of the first metal deflector panel and the second metal deflector panel are mounted onto the frame assembly, and
the first metal deflector panel includes a recessed perimeter section that is configured to wrap around at least a portion of the master cylinder mounting bracket of the off-road vehicle if the metal deflector panel is mounted onto the off-road vehicle.

8. The side-by-side, off-road vehicle according to claim 7, further comprising:
a metal adapter panel connected onto the first metal deflector panel and overlapping a space bound by the recessed perimeter section and the master cylinder bracket.

9. The side-by-side, off-road vehicle according to claim 1, further comprising:
a frame assembly supporting the passenger compartment;
a bumper main body mounted onto and extending away from the frame assembly,
a first bumper beam mounted on and extending away from the front bumper main body in the transverse direction;
a second bumper beam mounted on and extending away from each of the front bumper main body and the first bumper beam in the transverse direction;
a first guard plate connected to and extending from the bumper main body and the first bumper beam; and
a second guard plate connected to and extending from the bumper main body and the second bumper beam.

10. The side-by-side, off-road vehicle according to claim 9, wherein
each of the first body panel the second body panel are connected to the frame assembly,
each of the first metal deflector panel and the second metal deflector panel are mounted onto the frame assembly, and
the first metal deflector panel is located between the first bumper guard and passenger compartment in the longitudinal direction, and
the second metal deflector panel is located between the second bumper guard and passenger compartment in the longitudinal direction.

11. The side-by-side, off-road vehicle according to claim 1, wherein the first metal deflector panel is asymmetric to the second metal deflector panel about a longitudinal axis of the off-road vehicle that extends in the longitudinal direction and is centered on the off-road vehicle in the transverse direction.

12. The side-by-side, off-road vehicle according to claim 1, wherein at least one of the first metal deflector panel and the second metal deflector panel includes a contoured surface that faces away from the passenger compartment, the contoured surface configured such that an elongate object that enters one of the first wheel well and second wheel well is guided out of a respective one of the first wheel well and second wheel well.

13. An off-road vehicle comprising:
a plurality of tubes connected together to form a frame assembly that extends along a transverse direction of the vehicle and a longitudinal direction of the vehicle;
a passenger compartment defined by the frame assembly;
a first body panel that includes a first inner surface that forms at least a portion of a first wheel well;
a second body panel that includes a second inner surface that forms at least a portion of a second wheel well, the second wheel well is spaced away from the first wheel well in a transverse direction of the off-road vehicle;
a first metal deflector panel mounted onto the frame assembly at a location that is adjacent the first wheel well, at least a portion of the first metal deflector panel is spaced away from the first body panel in the longitudinal direction, the first metal deflector panel is configured to direct an object away from the passenger compartment if the object enters the first wheel well and strikes the first metal deflector panel; and
a second metal deflector panel mounted onto the frame assembly at a location that is adjacent the second wheel well, at least a portion of the second metal deflector panel is spaced away from the second body panel in the longitudinal direction, the second metal deflector panel is configured to direct an object away from the passenger compartment if the object enters the second wheel well and strikes the second metal deflector panel.

14. The off-road vehicle according to claim 13, further comprising:
a metal blocker plate, wherein
the frame assembly includes a cross beam that extends across the passenger compartment in the transverse direction, the cross beam is spaced above the first metal deflector panel and the second metal deflector panel in the vertical direction by a gap, the cross beam extends along the first metal deflector panel and the second metal deflector panel in the transverse direction,
the metal blocker plate is connected to the cross beam and spans the gap in the vertical direction, and
the second metal deflector panel is configured to deform and contact the metal blocker plate if an impact energy of an object striking the second metal deflector panel is greater than a predetermined threshold.

15. The off-road vehicle according to claim 13, further comprising:
a master cylinder bracket mounted onto the frame assembly at a location that is adjacent the first wheel well; and
a bumper guard mounted onto the frame assembly at a location that is spaced away from the master cylinder bracket in the longitudinal direction, the bumper guard is an elongated, polygonal panel, and overlaps at least a portion of the master cylinder bracket in the transverse direction and the vertical direction.

16. An off-road vehicle comprising:
a frame assembly that extends along a transverse direction of the vehicle and a longitudinal direction of the vehicle;
a bumper assembly mounted onto and extending away from the frame assembly;
a passenger compartment located within the frame assembly;
a first body panel that includes a first inner surface that forms at least a portion of a first wheel well;
a second body panel that includes a second inner surface that forms at least a portion of a second wheel well, the second wheel well is spaced away from the first wheel well in a transverse direction of the off-road vehicle;
a first suspension link pivotally mounted on the frame assembly;
a cushion connected to and extending from the frame assembly and the first suspension link;
a wheel pivotally connected to the first suspension link;
a first metal deflector panel mounted onto the frame assembly at a location that is between the first wheel and the first body panel in the longitudinal direction, the first metal deflector panel is configured to direct an object away from the passenger compartment if the object enters the first wheel well and strikes the first metal deflector panel; and
a second metal deflector panel mounted onto the frame assembly at a location that is between the second wheel and the second body panel in the longitudinal direction, the second metal deflector panel is configured to direct an object away from the passenger compartment if the object enters the second wheel well and strikes the second metal deflector panel.

17. The off-road vehicle according to claim 16, wherein
the bumper assembly, an outer edge of the first metal deflector panel, the wheel, the first suspension link, and the first cushion bound a first zone as viewed in the longitudinal direction from in front of the vehicle, and
the first metal deflector panel is configured to bend, against the wheel, the object if the objects includes a first end that enters the first zone and a second end that is seated in front of the vehicle on a travel path of the vehicle.

18. The vehicle according to claim 16, wherein
the bumper assembly includes a guard plate that is elongated in a direction that is inclined relative to the transverse direction,
the first suspension link, the guard plate, and the cushion bound a second zone as viewed in the longitudinal direction from in front of the vehicle,
the first metal deflector panel is configured to bend, against the cushion, the object if the object includes a first end that enters the second zone and a second end that is seated in front of the vehicle on the travel path.

19. The vehicle according to claim 16, further comprising:
a second suspension link pivotally mounted on the frame assembly and pivotally connected to the first wheel, wherein
the bumper assembly includes a bumper main body that extends along the transverse direction and the vertical direction,
the bumper main body, the first suspension link, the wheel, and the second suspension link bound a third zone as viewed in the longitudinal direction from in front of the vehicle, and
the first metal deflector panel is configured to bend, against the first suspension link and the second suspension link, the object if the object includes a first end that enters the third zone and a second end that is seated in front of the vehicle on the travel path.

20. The vehicle according to claim 16, further comprising:
a metal blocker plate, wherein
the frame assembly includes a cross beam that extends across the passenger compartment along the transverse direction,
the metal blocker plate is mounted on the cross beam and spaced away from the first metal deflector panel in the longitudinal direction,
the first wheel well includes a fourth zone,
the cushion extends diagonally across the fourth zone, and
the first metal deflector panel is configured to deform toward and onto the metal blocker plate if the object includes a first end that enters the fourth zone and a second end that is seated in front of the vehicle on the travel path and the object imparts an impact energy onto the first metal deflector panel that exceeds a predetermined threshold.
